(19) United States
(12) Patent Application Publication
(10) Pub. No.: US 2005/0056389 A1
(43) Pub. Date: Mar. 17, 2005

(54) Insect screen frame assembly

(76) Inventors: Timothy J. Kelley, Marine on the St. Croix, MN (US); David G. Green, New Richmond, WI (US)

Correspondence Address: WOMBLE CARLYLE SANDRIDGE & RICE, PLLC, P.O. BOX 7037, ATLANTA, GA, 30357-0037, US

(21) Appl. No.: 10/937,627

(22) Filed: Sep. 9, 2004

Related U.S. Application Data
(63) Continuation-in-part of application No. 10/348,045, filed on Jan. 20, 2003.

(51) Int. Cl. E06B 9/52

(52) U.S. Cl. 160/371

(57) ABSTRACT

An insect screen frame assembly including a frame comprising a screen retention groove and a cover. The cover is configured to engage the frame and comprises a rib positioned to be inserted into the groove. Screening is held in tension between the frame and the cover and trapped between the rib and the groove. A first adhesive is positioned between the frame and the cover in contact with the screening.

### CROSS-REFERENCE TO RELATED APPLICATION

This application is a continuation-in-part of application Ser. No. 10/348,045, filed Jan. 20, 2003, the contents of which are hereby incorporated in its entirety.

### BACKGROUND OF THE INVENTION

The invention generally relates to insect screens, such as for window or door units, screen porches, or other applications. Recently, new materials have been proposed for insect screening. These new materials are generally thinner than conventional screening materials and provide for improved visibility through the screening material.

Due to the small element diameter of the new insect screening materials, these screening materials present new challenges in tensioning and maintaining tension as the screening is disposed within a frame. Therefore, a need exists for an improved insect screen frame assembly capable of maintaining smaller element diameter screening material in tension.

### SUMMARY OF THE INVENTION

In accordance with the present invention, there is provided an insect screen. The screen includes a frame assembly comprising a series of frame members, each frame member having a first adhesive and a screen tensioning groove. A cover is configured to engage each frame member. The cover comprises a screen tensioning rib configured to be inserted into the screen tensioning groove and a second adhesive. Screening is initially held by the frame member and the first adhesive, and as the cover is rotatably applied, the screening is tensioned by the screen tensioning rib as it urges the screen into a position where it is disposed into the screen tensioning groove. The screen tensioning rib holds the screening in tension between the frame member and the cover. The second adhesive is positioned between the screening and the cover, in contact with the screening, so as to hold the cover in place after being rotatably applied to the screening. It is useful for the first and second adhesives to be sufficiently conformable to allow them to pass through the openings in the screening and adhere to the surface on the opposite side of the screening. It is also useful for the covers to have hook portions that fit over the outer edges of the frame members to aid in positioning. In some embodiments, the hook portions can also assist in holding the screen in place during the installation of the covers.

There is also provided a method for maintaining the position of screening under tension in a frame. The method includes providing a frame member comprising a screen contact surface, a first adhesive, and at least one screen tensioning groove. The screening is held in a fixed position by the first adhesive to the frame member. The method also includes providing a cover comprising a frame member contact side and a non-contact side opposite the frame member contact side. A screen tensioning rib is located on the frame member contact side and is configured to be disposed within the screen tensioning groove. A second adhesive is disposed on the frame member contact side and the cover is rotatably pressed against the frame member, so that the second adhesive, on the frame member contact side of the cover, is disposed against the screening 110 as it is pressed against the frame member. As the cover is rotated, the screen tensioning rib urges the screen into the screen tensioning groove, thereby tensioning the screening. A portion of the screening is disposed between the second adhesive and the frame member.

### BRIEF DESCRIPTION OF THE DRAWINGS

FIG. 1 is a front view of an insect screen frame assembly.

FIG. 2 is a side view of the insect screen of FIG. 1.

FIG. 3 is a back view of the insect screen of FIG. 1.

FIG. 4 is an isometric view of the insect screen of FIG. 1.

FIG. 5 is an isometric view of a clip used with the frame assembly.

FIG. 6 is a side cross-sectional view of a bottom rail.

FIG. 7 is a side cross-sectional view of a top rail or stile.

FIG. 8 is a side cross-sectional view of a stile during assembly showing the engagement of the frame member with the cover.

FIG. 9 is an exploded view of a support fixture for producing a framed screen.

FIG. 10 is an exploded view of the assembled support fixture and screen ready for the initial attachment of the screen to a frame.

FIG. 11 is a view of the screen in the support fixture after initial attachment to a frame.

FIG. 12 is a view of the screen after initial attachment to a frame, prior to installation of the covers.

FIG. 13 is an exploded view of a frame clip and corner key for the screen frame.

### DETAILED DESCRIPTION

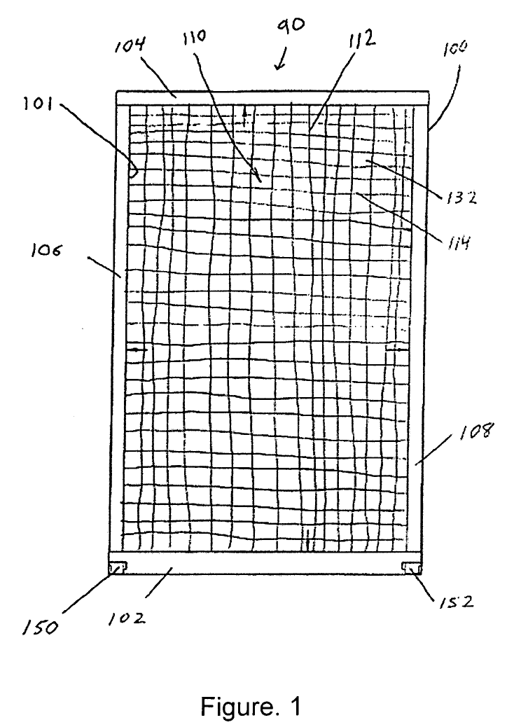

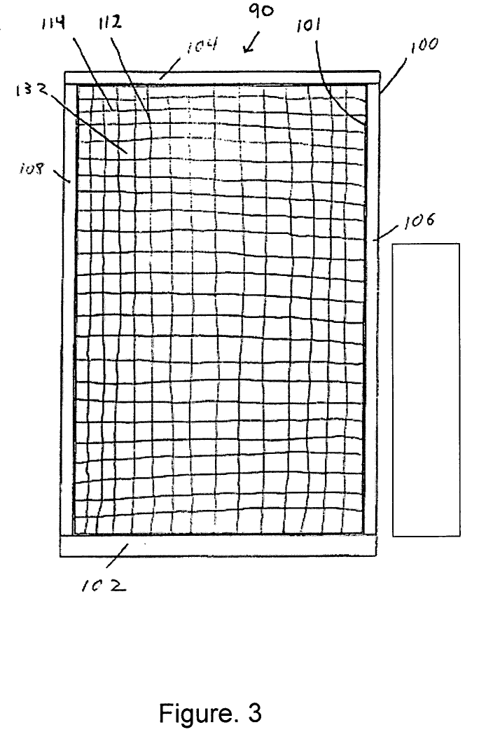

The present invention is applicable to many different types of window or door units that include insect screening in proximity to the windows or doors. For simplicity, the invention will be described mostly in the context of a window, although the invention can also be used with a door, screen porch, recreational vehicle, and other applications. FIGS. 1-4 illustrate one particular embodiment of an insect screen 90 including a frame assembly 100 in accordance with the invention. Insect screening 110 covers the frame opening defined by inner frame perimeter 101. The insect screen frame assembly 100 can be engaged to a frame surrounding window glass, a sash frame, a casement frame, or a frame of any window or patio door type or combination. The window is capable of being opened or closed. The window can be, for example, a bay window, bow window, projection window, a double-hung window, a roof window, egress window, an awning window, a casement window, a gliding window, and the like. In addition, the insect screen frame assembly can be used in a screen porch or other environment without an adjacent window or door, but is not restricted thereto.

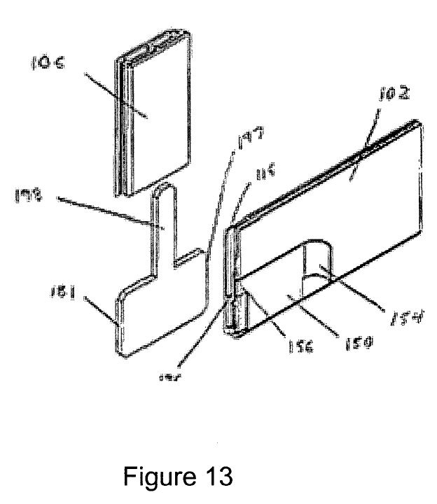

Typically as shown in FIG. 1, the frame assembly 100 can include two pairs of opposed frame members engaged with corresponding covers. A first pair of opposed frame members includes a bottom rail 102 and a top rail 104 that are oriented parallel to a horizontal frame axis. A second pair of opposed frame members includes a first side stile 106 and a second side stile 108 that are oriented parallel to a vertical frame axis. The four frame members 102, 104, 106, and 108 can generally form a square or rectangle shape. However, the insect screen 90 can be any shape and can include different numbers of frame members. The joinery of the frame assembly 100 can have a mortise and tenon appearance as is shown in FIGS. 1-4. Alternatively, the frame assembly can have a 45 degree miter appearance. Further, a frame assembly could have mortise and tenon joinery on the bottom rail to stile joints and 45 degree miter joinery on the stile to top rail joints. The frame members can be joined structurally by corner keys that insert into the hollow described by the frame member profile. FIG. 13 represents one such corner key and frame member profile. Another way to structurally join the frame members is to include geometry such as a screw chase in the frame member profile that can accept fasteners. There are many known ways that frame members can be joined as would be apparent to one skilled in the art, all of which are encompassed herein.

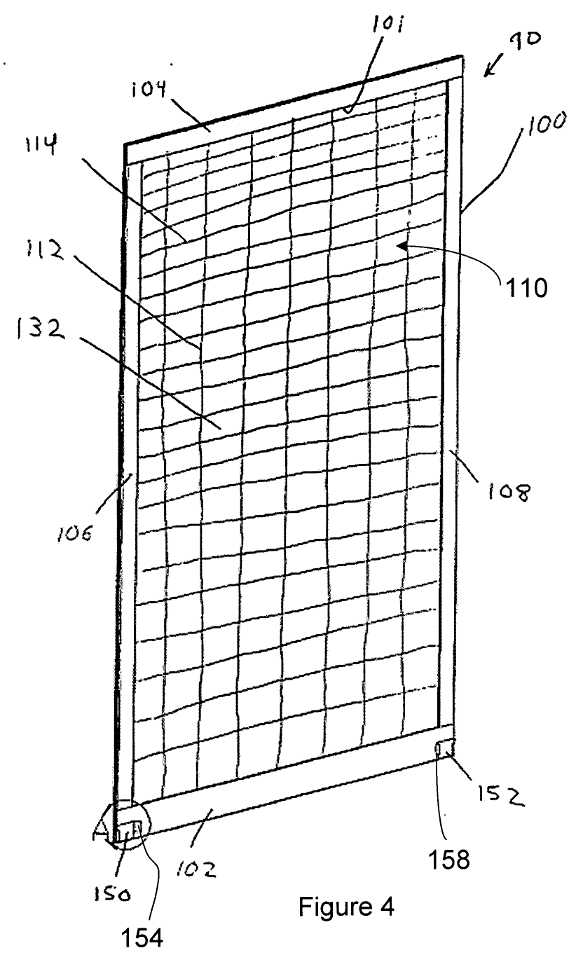

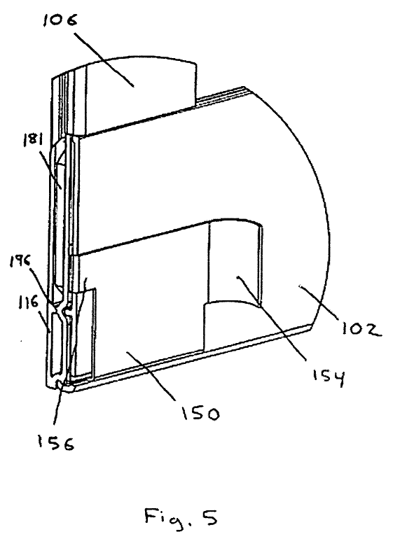

Referring again to FIG. 4, the insect screen frame assembly 100 can also include locking clips 150 and 152 to lock assembly 100 to a frame, such as the frame of a window or door. Locking clips 150 and 152 also incorporate handles 154 and 158 that allow easier removal of assembly 100 from a frame of a window or door. Locking clip 150 is shown with more detail in FIG. 5. Locking Clip 152 comprises a similar configuration as locking clip 150, and is substantially a mirror image of locking clip 150. Preferably, for easier access for replacement, repair, or other manipulation, the locking clips 150 and 152 are positioned on the side of the frame assembly that face the interior of a structure that they are used within.

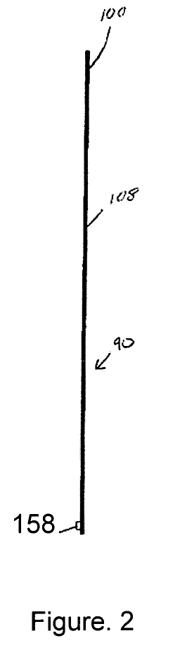

Handles 154 and 158 are included on locking clips 150 and 152 to enable a user to more effectively manipulate frame assembly 100 or locking clips 150 and 152. Handle 158 is shown extending outward from the interior side of the frame assembly 100 in FIG. 2. However, alternative embodiments are possible in which handles 154 and 158 do not extend outward from frame assembly 100. Generally, a user can position bottom rail 104 in a corresponding groove located in a window or door unit. The user then moves bottom rail 102 of frame assembly 100 toward the window until bottom rail 102 is tight with the frame of the window or door unit. The user slides locking clips 150 and 152 away from the center of bottom rail 102 toward locking clip receiving apertures of a frame (not shown) of a window or door unit until catch 156 of clip 150 and its counterpart catch in clip 152 slide into catch receiving apertures of the frame. The user can slide locking clips 150 and 152 away from the center of bottom rail 102, into locking clip receiving apertures using handles 154 and 158. Alternatively, locking clips 150 and 152 can be connected to spring mechanisms, which automatically bias locking clips 150 and 152 away from the center of rail 102, toward locking clip receiving apertures.

FIG. 13 shows an exploded view illustrating the assembly of bottom rail 102 with stile 106. In an alternative embodiment, bridge 196 is shown in the profile of frame member 116. Bridge 196 typically adds support to frame member 116, although such support is not necessary to the invention. Bridge 196 can also assist the insertion of corner key 181 into frame member 116. Corner key 181 is generally shown as a “T” shape. However, corner key 181 can also generally comprise an “L” shape or a variety of other shapes while remaining within the scope of the invention. During assembly, lock 197 can be inserted in the end of frame member 116. Next, tab 198 can be inserted into a corresponding frame member, such as stile 106, thereby forming the frame assembly. In some embodiments, it may be desirable to use adhesive on lock 197 or tab 198 to further secure the corner keys to the frame members.

Screening 110 is disposed within the open area defined by inner frame perimeter 101 of insect screen frame assembly 100. Screening 110 generally defines a portion of a plane and includes a plurality of individual elements. Element 112 is shown parallel to stile 106 and stile 108. Element 114 is shown parallel to bottom rail 102 and top rail 104. However, the elements of screening 110 can comprise a variety of configurations. Openings 132 are located between individual elements of screening 110. The size of openings 132 depends on the distance between the horizontal and vertical screening elements. The screening 110 shown in FIGS. 1, 3, and 4 is not drawn to scale, for ease of illustrating the individual elements. The claimed screen frame is particularly useful for screening materials having smaller screen element diameters than conventional screens.

In one embodiment, the insect screening material includes screen elements having a diameter of about 0.005 inch (0.13 mm) or less. The screen elements have a tensile strength of at least about 5500 psi (37.921 mega Pascals). The light transmittance of the screening 110 is at least about 0.70 and the reflectance of the screening 110 is about 0.04 or less to reduce the visibility of the screening. Examples of screening 110 are discussed in U.S. patent application Ser. Nos. 10/068,069 and 10/259,221, both titled “REDUCED VISIBILITY INSECT SCREEN” and filed on Feb. 6, 2002 and Sep. 26, 2002, respectively, which are incorporated herein by reference.

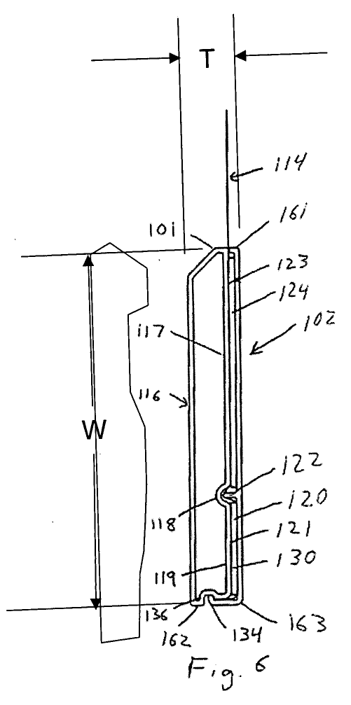

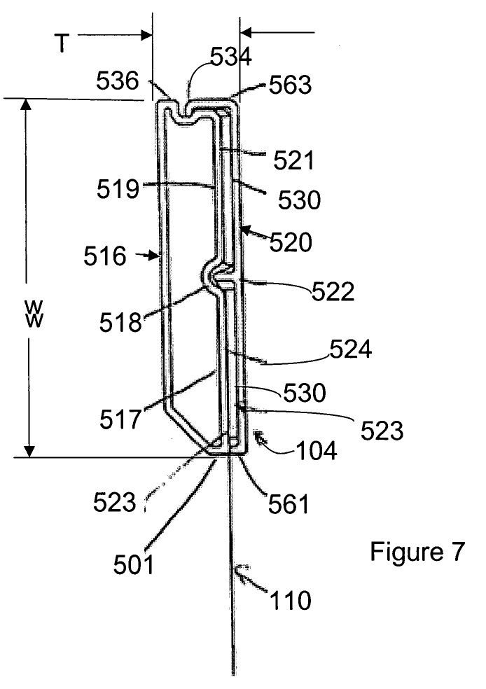

FIG. 6 shows a cross sectional view of bottom rail 102. Element 112 is shown disposed within bottom rail 102. FIG. 7 shows a cross-sectional view of top rail 104. In a preferred embodiment, the cross-sections of stiles 106 and 108 are identical to the cross section of top rail 104, however, a variety of configurations are possible within the scope of the invention. For example, all rails and stiles could have the same dimension W or a different dimension W. It is preferred that dimension T of the rails and stiles be the same, so as to provide a frame of uniform thickness after joining.

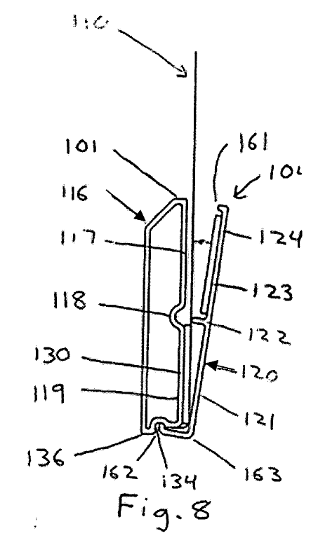

With reference to FIGS. 6-8, the details of the cross-sectional configuration of the rails and stiles will now be discussed. The cross sectional view of stile 106 is shown in FIG. 8 during assembly. However, bottom rail 102, top rail 104, and stile 108 generally comprise similar cross-sectional configurations with similar components. Referring to FIG. 8, stile 106 is generally comprised of frame member 116 and cover 120. Cover 120 is configured to engage frame member 116 with screening 110 generally disposed between cover 120 and frame member 116. The frame member 116 includes groove 134 suitable for engaging hook portion 163 of cover 120.

With reference to frame member 116 the inner portion 117 is defined as the portion of the frame member 116 between the screen tensioning groove 118 and the inner frame perimeter 101. The outer portion 119 of the frame member 116 is defined as the area of the frame member 116 between the screen tensioning groove 118 and the outer frame opening 162 where the screening 110 first comes into contact with the rail or stile. A frame assembly 100 is multiple frame members joined to enclose an inner frame perimeter 101 area for screening, such as four frame members joined in a rectangle, before the covers are added. Preferably, the screen tensioning groove 118 extends continuously around the frame assembly 100.

With reference to cover 120, the inner portion 123 is defined as the portion of the cover 120 between screen tensioning rib 122 and the inner cover perimeter 161. The outer portion 121 of the cover 120 is defined as the area of the cover between the screen tensioning rib 122 and the outer cover opening 163 where the screening 110 first comes into contact with the rail or stile. Frame member 116 includes a screen tensioning groove 118 disposed in the surface of the frame member 116 that engages the cover 120. Screen tensioning groove 118 is generally parallel to the outer frame perimeter 162. Cover receiving groove 136 can also be located on frame member 116. Groove 136 is useful for positioning cover 120 with respect to frame member 116. Groove 136 is preferably located along the outer frame perimeter 162 of the frame member 116, although alternative locations are possible.

FIG. 7 shows a cross sectional view of top rail 104, with screening 110 installed. With reference to frame member 516 the inner portion 517 is defined as the portion of the frame member 516 between the screen tensioning groove 518 and the inner frame perimeter 501. The outer portion 519 of the frame member 516 is defined as the area of the frame member 516 between the screen tensioning groove 518 and the outer frame perimeter 562.

With reference to cover 520, the inner portion 523 is defined as the portion of the cover 520 between the screen tensioning rib 522 and the inner cover perimeter 561 where the screening 110 first comes into contact with top rail 104. The outer portion 521 of the cover 520 is defined as the area of the cover 520 between the screen tensioning rib 522 and the outer cover perimeter 563.

Frame member 516 includes a screen tensioning groove 518 disposed in the surface of the frame member 516. Screen tensioning groove 518 is generally parallel to the outer frame perimeter 562. Groove 536 can also be located on frame member 516. Groove 536 is useful for positioning cover 520 with respect to frame member 516. Groove 536 is preferably located along the outer frame perimeter 562 of the frame member 516, although additional locations are possible. Other mechanical engagement means could be used as would be apparent to one skilled in the art.

In FIG. 8, cover 120 is shown being brought into engagement with frame member 116, after positioning screening 110 on first adhesive layer 130. Cover 120 includes screen tensioning rib 122 positioned to engage screen tensioning groove 118. The combination of screen tensioning rib 122 and screen tensioning groove 118 are useful for providing pressure against screening 110 to keep screening 110 in tension between rails 102, 104 and stiles 106, 108. For example, cover 120 is shown at an angle of about 8 degrees with respect to frame member 116 as the cover 120 is positioned on the frame member 116 during assembly. At an 8 degree angle, screen tensioning rib 122 contacts screening 110 and pushes some elements of screening 110 into screen tensioning groove 118. This action tensions screening 110 and provides additional friction to keep screening 110 in tension. Screen tensioning rib 122 can contact screening 110 when cover 120 is at a variety of angles with respect to frame member 116. For example, exemplary contact angles range from 5 degrees to 35 degrees. Higher contact angles generally secure screening 110 with more tension than lower contact angles of the cover 120 and frame member 116. When the installation of cover 120 is completed, second adhesive 124 contacts and adheres to screening 110, thereby holding the screening in place. It is useful for adhesive 124 to be sufficiently conformable to allow it to flow through the openings in screening 110 and adhering to inner portion 117 of frame member 116.

Screen tensioning rib 122 is shown with a generally elongated shape. However, screen tensioning rib 122 can comprise a variety of configurations while serving the function of tensioning screening 110 and maintaining screening 110 in tension. For example, screen tensioning rib 122 can also be jagged, elliptical, or of any other suitable shape, as would be apparent to one skilled in the art. Screen tensioning rib 122 is shown extending from cover 120 at approximately a 90 degree angle. However screen tensioning rib 122 can extend from the cover 120 at a variety of angles. In a preferred embodiment, screen tensioning rib 122 extends from the cover at an angle between 80 and 100 degrees.

Cover 120 can also include hook 134. Hook 134 is used to engage groove 136 on frame member 116. The combination of hook 134 and groove 136 is useful for positioning cover 120 with respect to frame member 116, and for resisting creep that could occur in the adhesive layers due to tension in screening 110. Other mechanical engagement means could be used as would be apparent to one skilled in the art. In an alternative embodiment, the outer perimeter of screening 110 can extend beyond outer perimeter 134 of frame member 116, so that when cover 120 is installed, screening 110 is captured between hook portion 134 and groove 136, thereby aiding in tensioning of screening 110 as cover 120 is rotated into place.

Second adhesive 124 can be a pressure sensitive, hot melt, or other suitable adhesive. In a preferred embodiment, adhesive 124 includes a high performance pressure sensitive tape. A high performance pressure sensitive tape is generally defined as capable of essentially permanently supporting loads of greater than 300 grams per square centimeter of adhesive at temperatures of 150° F. (65° C.) or higher.

In addition to contacting screening 110, adhesive 124 can also contact the engaging surface of frame member 116 through openings 132 in screening 110. This configuration is believed to further secure screening 110.

In another embodiment, a first adhesive 130 can be disposed on frame member 116. A first adhesive 130 is shown on the surface of frame member 116 between screen tensioning groove 118 and groove 136 on the outer portion 119 of the frame member. First adhesive 130 can comprise double sided tape or hot melt adhesive. In a preferred embodiment, first adhesive 130 also includes a high performance adhesive or pressure sensitive tape. Adhesive 130 preferably exhibits a non-creep property, which prevents screening 110 from losing tension within the frame assembly 100. In addition to contacting screening 110, adhesive 130 can also contact the engaging surface of cover 120 through openings 132 in screening 110. This configuration is believed to further secure screening 110. First adhesive 130 is useful for holding screening 110 in place prior to tensioning by cover 120, and for holding the outer edges of screening 110 in place during tensioning, so that displacement of screening 110 by tensioning rib 122 occurs in the inner area of screening 110, rather than at the outer perimeter, thereby tensioning screening 110.

The first and second adhesives for attaching the screening 110 to the frame member 116 and cover 120 can be the same or different. Suitable adhesives for each application include those having sufficient shear strength and creep resistance to hold the screen in tension for significant periods of time. Pressure sensitive adhesives can be used, provided that they have sufficient shear strength and resistance to creep. An additional feature useful for pressure sensitive adhesives is that they have a level of conformability sufficient to allow them to pass through the open areas of the screening 110 and adhere to the adjacent frame member or cover. Pressure sensitive adhesive systems particularly useful in this regard are those comprising foam backings having pressure sensitive adhesive layers attached to each major surface thereof.

Foams particularly useful as backings for pressure sensitive adhesives in the present invention are those commonly referred to as syntactic foams. A syntactic foam comprises a polymeric matrix surrounding hollow microbeads, microballoons, or microbubbles, as they are variously called. Hollow microbeads made of flexible polymeric materials are preferred, since they provide the foam backing with flexibility, and hence conformability, while at the same time contributing to the strength of the foam material under various conditions of tensile and shear loading. In forming the polymeric matrix for the foam, crosslinkable polymeric materials, in particular acrylates and methacrylates have been found useful. Useful foams are disclosed in U.S. Pat. No. 6,103,152, incorporated herein by reference.

In producing the pressure sensitive adhesive layers attached to the foam backing, crosslinked pressure sensitive adhesives, especially acrylic adhesives, have been found useful. Examples of useful adhesives are disclosed in U.S. Pat. No. 5,695,837, and in U.S. Pat. No. 6,448,337, both incorporated herein by reference. It is also contemplated that some pressure sensitive adhesives can undergo post-application treatments, such as heat curing, to improve adhesion, provided that such curing can be performed without producing adverse effects such as loss of screen tension. An especially useful class of pressure sensitive adhesive materials is the VHBFM line of foam tapes, commercially available from 3M Company, St. Paul, Minn.

In an alternative, the first and second adhesive can comprise a hot melt adhesive. Hot melt adhesives are resinous adhesives, which achieve a solid state and resultant strength by cooling. Before heating, a hot-melt adhesive is a thermoplastic, 100% solid material. Upon the application of heat, the usual operating temperature is in the range of 175 to 205 deg. C. (350 to 400 deg. F.), the material changes to a fluid state. Once the heat is removed, the adhesive sets by simple cooling.

One or more fasteners (not shown) can also fasten cover 120 to frame member 116. The fasteners can comprise a variety of forms including staples, nails, screws, bolt, hinged mechanisms, welds, snap fits, or latches. Fasteners can operate in conjunction with adhesives 124 and 130. In an alternative embodiment, a fastener can operate without the use of any adhesive on cover 120 and frame member 116. Fasteners can allow the cover to be tightened over time and further tension the screening. For example, tightening the fasteners could bring the screen tensioning rib into further engagement with the screen tensioning groove to further tension the screening.

Cover 120 and frame member 116 can be constructed from a variety of materials. In a preferred embodiment, cover 120 and frame member 116 are formed from aluminum. However, in alternative embodiments, any one or both of cover 120 and frame member 116 can be formed from a thermoplastic material, roll-formed steel, a PVC/wood fiber composite, or other composite materials. Examples of PVC/wood composite material are disclosed in U.S. Pat. Nos. 5,441,801; 5,486,553; 5,497,594; 5,518,677; 5,539,027; 5,695,874; 5,773,138, the disclosures of which are incorporated herein by reference.

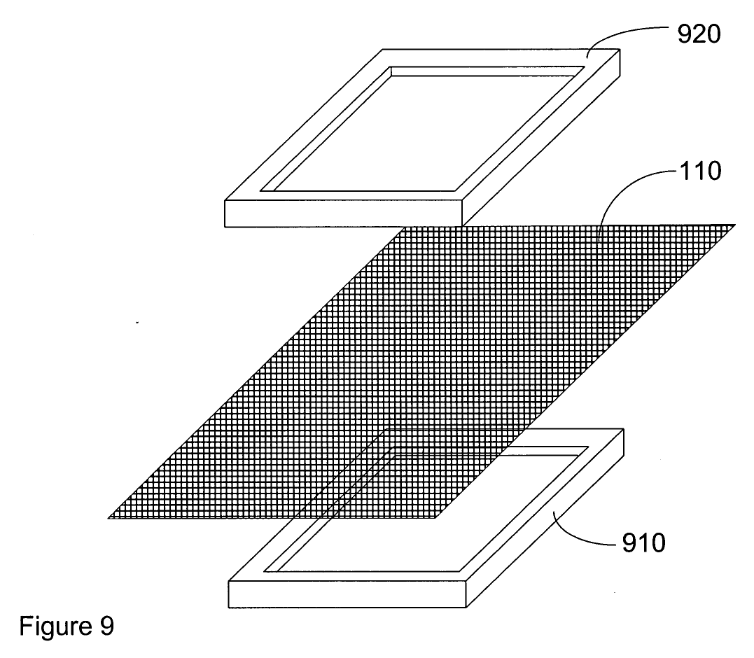

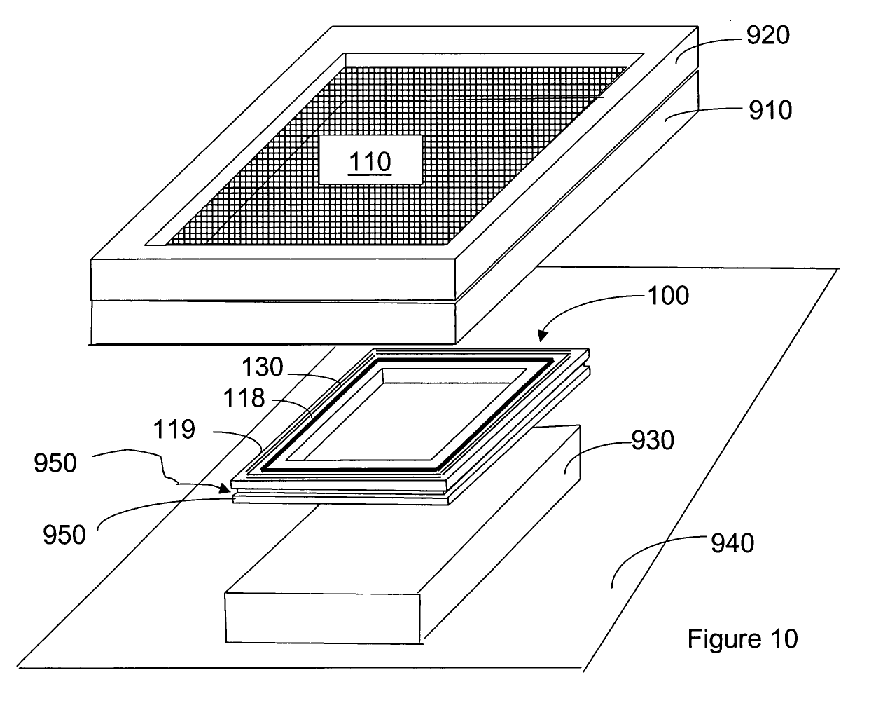

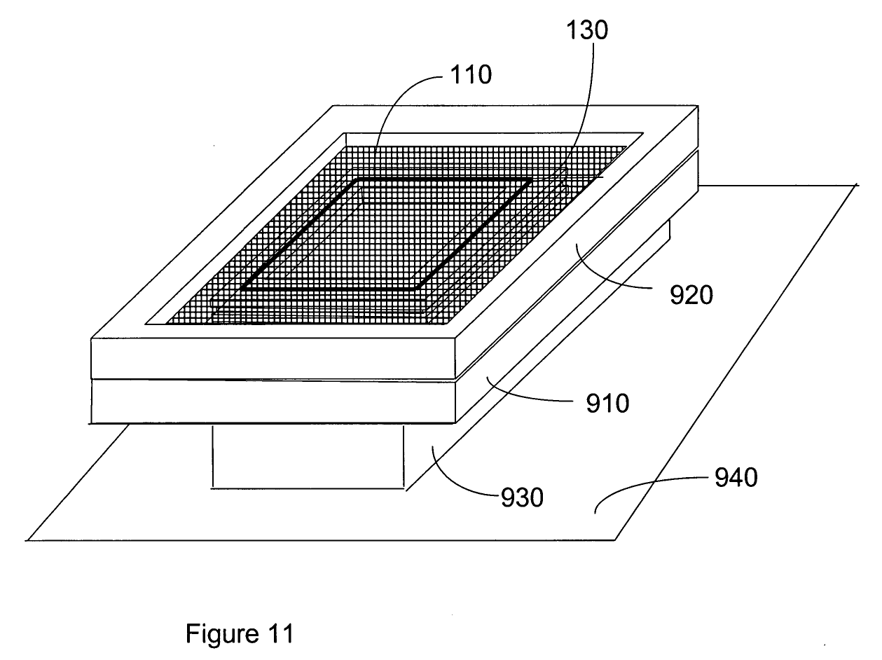

With reference to FIGS. 9-12, a method of constructing an insect screen will now be discussed. First, screening 110 is clamped between support fixture members 910 and 920 and while being adjusted to be fairly evenly positioned within the support structure. Members 910 and 920 are held together by bolts, clamps, or any other suitable holding devices, as would be apparent to one skilled in the art. Support fixture members 910 and 940 can comprise a square, rectangle, or other shape, preferably corresponding to but slightly larger than the shape of the frame assembly 100. Referring to FIG. 10, frame assembly 100 is elevated above surface 940 by base support 930. Once screening 110 is clamped between support fixture members 910 and 920, screening 110 is placed over frame assembly 100, as shown in FIG. 11, so that screening 110 contacts first adhesive layer 130. Base support 930 rests on surface 940. Base support 930 is also rectangular or corresponds to the shape of the frame assembly.

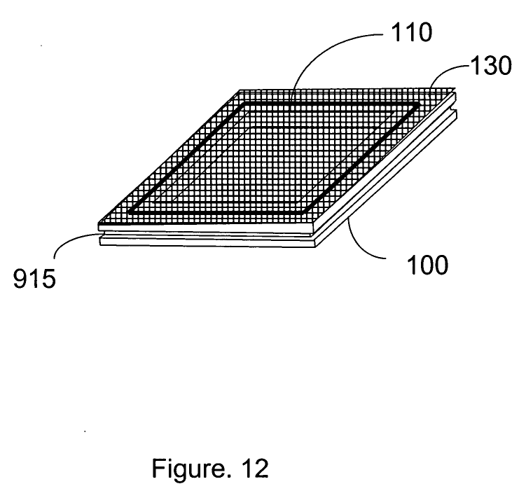

Once screening 110 has been placed in contact with first adhesive layer 130, it can be pressed down, using a roller or other suitable means, as would be apparent to one skilled in the art, to produce an adhesive bond. Screening 110 can then be trimmed around outer perimeter 950 of frame assembly 100, so as to enable support fixture members 910 and 920 to be removed, along with the excess screening, resulting in the subassembly shown in FIG. 12.

Finally, covers are installed by hooking them into peripheral groove 915 and rotating them into place until the tensioning ribs urge screening 110 into the tensioning grooves. After hooking, adhesive 124 on covers 120 contacts the screening 110, thereby bonding adhesive 124 to screening 110 and holding screening 110 in tension and further providing some bonding of the cover to the frame members through the openings in the screening. The covers 120 are installed for each of the stiles and rails to form the insect screen frame assembly 100.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An insect screen comprising:
a frame having a screen tensioning groove;
a cover configured to engage the frame, the cover comprising a tensioning rib configured to be inserted into the groove;
screening held between an outer portion of the frame and an outer portion of the cover by a first adhesive layer, wherein the screening is tensioned by the tensioning rib urging the screening into the tensioning groove.

2. The insect screen of claim 1, further comprising a second adhesive layer, wherein the second layer is disposed between an inner portion of the cover and the screening.

3. The insect screen of claim 1, wherein the cover further comprises a hook portion that engages an outer periphery of the frame.

4. A method of producing an insect screen, comprising the steps of:
providing a frame, wherein the frame has a screen tensioning groove;
providing a first adhesive layer to a portion of the frame between the screen tensioning
groove and an outer periphery of the frame;
applying a screening material to the adhesive layer;
installing a cover over the screening material, wherein the cover comprises a screen;
tensioning rib that urges the screening into the groove.
